(19) United States
(12) Patent Application Publication
(10) Pub. No.: US 2009/0280791 A1
(43) Pub. Date: Nov. 12, 2009

(54) SYSTEM AND METHOD FOR MONITORING COMMUNICATION RECORDS OF A COMMUNICATION DEVICE

(75) Inventor: YEOU-JONG CHEN, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: CHI MEI COMMUNICATION SYSTEMS, INC., Tu-Cheng City (TW)

(21) Appl. No.: 12/250,542

(22) Filed: Oct. 14, 2008

(30) Foreign Application Priority Data
May 12, 2008 (CN) 200810301547.X

(51) Int. Cl. H04W 88/00

(52) U.S. Cl. 455/418

(57) ABSTRACT

A method for monitoring communication records of a communication device is disclosed. The method generates the communication records of the communication device, and sends the communication records to a controller according to preset data, such as basic information of the monitor and a monitoring mode. A system for monitoring communication records of a communication device is also provided. By utilizing the method and the system, the communication records of the communication device may be monitored by someone needs to control/manage/track the communication device.

### BACKGROUND

1. Field of the Invention

Embodiments of the present disclosure relate to monitoring systems and methods, and more particularly to a system and method for monitoring communication records of a communication device.

2. Description of Related Art

With rapid development of communication, portable electronic devices, such as mobile phones are now in widespread use. In the past, the cost of mobile phones and communication services were expensive and this limited usage of mobile by common users. In recent years, the cost of mobile phones have fallen steeply, and mobile phones are now more affordable and have more functionality.

Mobile phones are so ubiquitous that adolescent (e.g., high school students) and even children are entrusted with mobile phones by their parents. However, some of these adolescent and children may not understand or be aware of mobile phone charges, and thus may use their mobile phones indiscriminately, which may result in expensive phone charges. That is, it is necessary to know the communication records of the mobile phones so as to control the adolescent and the children using the mobile phones properly. In another aspect, when a company provides the mobile phones to employees for communicating with clients of the company, it is important to know how the mobile phones are used, for the purpose of reducing communication costs of the company.

What is needed, therefore, is an improved system and method for monitoring communication records of a communication device to overcome the above-stated problems.

### SUMMARY

A computing system for monitoring communication records of a communication device is provided. The computing system includes a setting module, a recording module, and a sending module. The setting module is configured for setting basic information of a controller of the communication device, and setting a monitoring mode for monitoring the communication records of the communication device. The recording module is configured for recording communication information of the communication device, generating communication records according to the communication information, and storing the communication records into a storage system of the system. The sending module is configured for reading corresponding communication records in the storage system according to the set monitoring mode, and sending the read communication records to the controller according to the basic information of the controller.

Other advantages and novel features of the present disclosure will be drawn from the following detailed description of certain inventive embodiments of the present disclosure with reference to the attached drawings.

### BRIEF DESCRIPTION OF THE DRAWINGS

FIG. 1 is a block diagram of one embodiment of a system for monitoring communication records of a communication device.

FIG. 2 is a block diagram of one embodiment of user interfaces of the system of FIG. 1.

FIG. 3 is a flowchart of one embodiment of a method for monitoring communication records of a communication device.

### DETAILED DESCRIPTION OF CERTAIN INVENTIVE EMBODIMENTS

All of the processes described below may be embodied in, and fully automated via, software code modules executed by one or more general purpose computers or processors. The code modules may be stored in any type of computer-readable medium or other storage device. Some or all of the methods may alternatively be embodied in specialized computer hardware or communication apparatus.

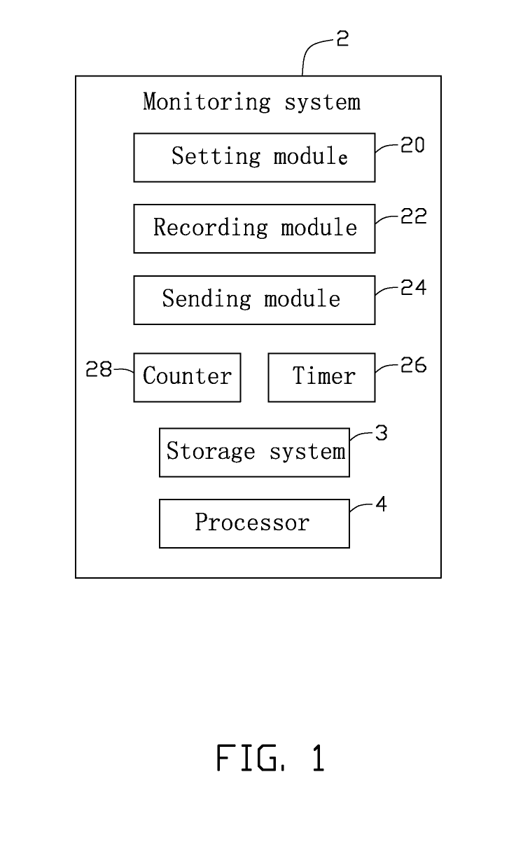

FIG. 1 is a block diagram of one embodiment of a system 2 for monitoring communication records of a communication device (hereinafter referred to as “the monitoring system 2”). Depending on the embodiment, the monitoring system 2 may be any kind of communication device (e.g., mobile phone), for example. The monitoring system 2 is used for monitoring communication records of the communication device. The communication records may include various communication information, such as incoming call numbers, outgoing call numbers, a call start time, a call end time, and a call time length, etc. In an other embodiment, the communication records may include short messages received or sent by the communication device.

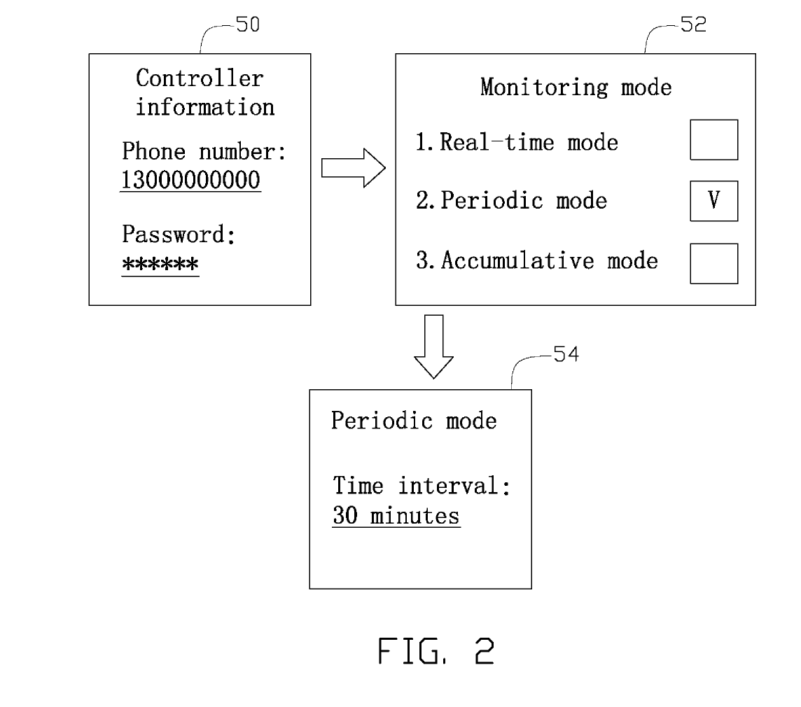

The monitoring system 2 provides various user interfaces (UIs) for users to perform different operations, such as, starting the monitoring system 2, setting data in the monitoring system 2, and so on. In one embodiment, as shown in FIG. 2, the monitoring system 2 provides, but is not limited to, a controller information interface 50, a monitoring mode interface 52, and a periodic mode interface 54.

In one embodiment, the monitoring system 2 may comprise a setting module 20, a recording module 22, a sending module 24, a timer 26, and a counter 28. The monitoring system 2 may further comprise a storage system 3 and at least one processor 4. The modules 20, 22, 24, 26 and 28 may be used to perform one or more operations for the monitoring system 2.

Additionally, the monitoring system 2 may comprise one or more specialized or general purpose processors, such as the processor 4 for executing the modules 20, 22, 24, 26 and 28. The storage system 3 is for storing various kinds of data, such as the data set by the monitoring system 2, the communication records of the communication device, etc. Depending on the embodiment, the storage system 3 may be a memory of the communication device or an external storing card, such as a memory stick, a Subscriber Identity Module (SIM) card, or some combination thereof, but the disclosure is not limited thereto.

The setting module 20 is configured for setting basic information of a controller of the communication device. The controller is a person who wants to know the communication records of the communication device. The basic information of the controller may include, but is not limited to, a phone number of a communication device of the controller, and passwords for accessing the monitoring system 2. The passwords are required to modify various data set in the communication device via the monitoring system 2.

The setting module 20 is further configured for setting a monitoring mode for monitoring the communication records of the communication device. In the embodiment of present disclosure, the monitoring mode may include a real-time mode, a periodic mode, and an accumulative mode. Under the real-time mode, the communication records of the communication device 1 are sent to the controller instantly once a new communication record is generated. Under the periodic mode, the setting module 20 presets a time interval (e.g., 30 minutes) and the communication records are sent to the controller periodically according to the time interval. Under the accumulative mode, the setting module 20 presets a threshold (e.g., 20 records), then unsent communication records are sent to the controller when a counted number of the unsent communication records accumulates to the preset threshold.

The recording module 22 is configured for recording communication information of the communication device, generating corresponding communication records according to the communication information, and storing the communication records in the storage system 3.

The sending module 24 is configured for reading the corresponding communication records in the storage system 3 according to the monitoring mode set by the setting module 20, and sending read communication records to the controller according to the basic information (e.g., the phone number) of the controller.

Specifically, under the periodic mode, if the time interval is preset as “30 minutes” (as shown in FIG. 2), the timer 26 times the time interval once the monitoring system 2 is started. The sending module 24 reads the communication records generated within the time interval, and sends the read communication records to the controller. When the read communication records have been sent to the controller, the timer 26 resets to zero.

Under the accumulative mode, if the threshold is preset as “20 times,” the counter 28 counts the counted number of the communication records when starting the monitoring system 2. Then the sending module 24 reads the unsent communication records if the counted number accumulates to the preset threshold, and sends the read unsent communication records to the controller. When the read unsent communication records have been sent to the controller, the counter 28 resets to zero.

FIG. 2 is a block diagram of one embodiment of the UIs of the monitoring system 2 of FIG. 1. In one embodiment, the monitoring system 2 provides the controller information interface 50, the monitoring mode interface 52, and the periodic mode interface 54.

The phone number of the controller and corresponding passwords are inputted by using the controller interface 50. Using the monitoring mode interface 52, one monitoring mode is selected to monitor the communication records of the communication device 1. As shown in FIG. 2, the periodic mode is selected, and then the periodic mode interface 54 is shown for setting the time interval.

In other embodiments, the monitoring system 2 may provide more different UIs for different operations.

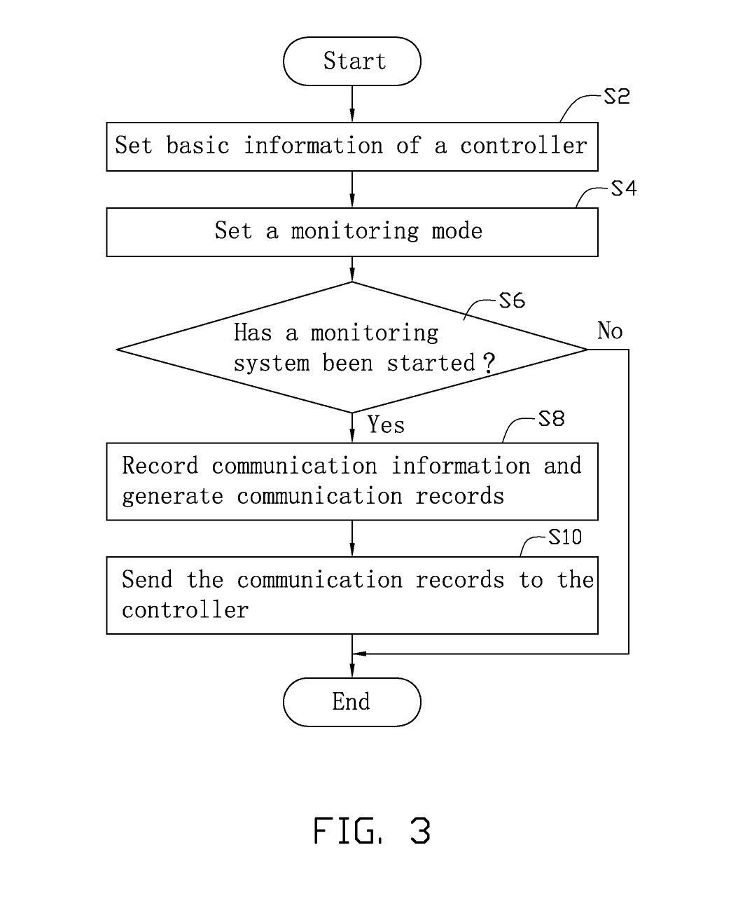

FIG. 3 is a flowchart of one embodiment of a method for monitoring communication records of a communication device. Depending on the embodiment, additional blocks may be added, others removed, and the ordering of the blocks may be changed.

In block S2, the setting module 20 sets basic information of a controller of the communication device. The basic information of the controller may include, but is not limited to, a phone number of the controller, and passwords for accessing the monitoring system 2.

In block S4, the setting module 20 sets one monitoring mode for monitoring the communication records of the communication device. In the embodiment of present disclosure, the monitoring mode may include the real-time mode, the periodic mode, and the accumulative mode.

In block S6, a determination as to if the monitoring system 2 has been started, for monitoring the communication records of the communication device, is made. If the monitoring system 2 is started, in block S8, the recording module 22 records communication information of the communication device, generates communication records according to the communication information, and stores the communication records in the storage system 3. Otherwise, if the monitoring system is not started, the procedure ends.

In block S10, the sending module 24 reads corresponding communication records in the storage system 3 according to the monitoring mode set by the setting module 20, and sends read communication records to the controller according to the basic information (e.g., the phone number) of the controller.

In other embodiment, the recording module 22 may store the communication records in the storage system 3 upon the condition that the monitoring system 2 is not started. The communication records in the storage system 3 are not allowable to be modified or canceled without identifying the passwords.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A computing system for monitoring communication records of a communication device, the system comprising:
a setting module configured for setting basic information of a controller of the communication device, and setting a monitoring mode for monitoring the communication records of the communication device;
a recording module configured for recording communication information of the communication device, generating communication records according to the communication information, and storing the communication records into a storage system of the system;
a sending module configured for reading corresponding communication records in the storage system according to the set monitoring mode, and sending the read communication records to the controller according to the basic information of the controller; and
at least one processor for executing the setting module, the recording module, and the sending module.

2. The system according to claim 1, wherein the monitoring mode comprises:
a real-time mode that reads a communication record instantly once a new communication record is generated in the communication device;
a periodic mode that reads communication records periodically; and
an accumulative mode that reads unsent communication records once a counted number of the communication records accumulates to a threshold.

3. The system according to claim 2, wherein the threshold is preset by the setting module.

4. The system according to claim 2, wherein the setting module is further configured for setting a time interval for sending the communication records periodically.

5. The system according to claim 2, further comprising a timer configured for timing under the periodic mode.

6. The system according to claim 3, wherein the timer resets to zero when the read communication records have been sent to the controller.

7. The system according to claim 2, further comprising a counter configured for counting the counted number of the unsent communication records under the accumulative mode.

8. The system according to claim 7, wherein the counter resets to zero when the read unsent communication records have been sent to the controller.

9. The system according to claim 1, wherein the basic information of the controller comprises phone numbers of the controller.

10. The system according to claim 1, wherein the communication information comprises at least one from the group consisting of incoming call numbers, outgoing call numbers, a call start time, a call end time, and a call time length.

11. A computer-implemented method for monitoring communication records of a communication device, the method comprising:
setting basic information of a controller of the communication device, and setting a monitoring mode for monitoring the communication records of the communication device;
recording communication information of the communication device;
generating communication records according to the communication information, and storing the communication records in a storage system of the communication device;
reading corresponding communication records in the storage system according to the set monitoring mode; and
sending the read communication records to the controller according to the basic information of the controller.

12. The method according to claim 11, wherein the monitoring modes comprises:
a real-time mode that reads a communication record instantly once a new communication record is generated in the communication device;
a periodic mode that reads communication records periodically; and
an accumulative mode that reads unsent communication records once a counted number of the communication records accumulates to a threshold.

13. The method according to claim 12, further comprising:
setting a time interval under the periodic mode;
timing when beginning to monitor communication records of the communication device;
reading the communication records generated within the time interval, and sending the read communication records to the controller.

14. The method according to claim 12, further comprising:
presetting the threshold under the accumulative mode;
counting the counted number of the unsent communication records when beginning to monitor the communication records of the communication device; and
reading corresponding unsent communication records if the counted number accumulates to the preset threshold, and sending the read unsent communication records to the controller.

15. The method according to claim 11, wherein the basic information of the controller comprises phone numbers of the controller.

16. The method according to claim 11, wherein the communication information comprises incoming call numbers, outgoing call numbers, call start time, call end time, and a call time length.

17. A computer-readable storage having stored thereon instructions that, when executed by a processor, causing the processor to perform a method for monitoring communication records of a communication device, the method comprising:
setting basic information of a controller of the communication device, and setting a monitoring mode for monitoring the communication records of the communication device;
recording communication information of the communication device;
generating communication records according to the communication information, and storing the communication records in a storage system of the communication device;
reading corresponding communication records in the storage system according to the set monitoring mode; and
sending the read communication records to the controller according to the basic information of the controller.

18. The method according to claim 17, wherein the monitoring modes comprises:
a real-time mode that reads a communication record instantly once a new communication record is generated in the communication device;
a periodic mode that reads communication records periodically; and
an accumulative mode that reads unsent communication records once a counted number of the communication records accumulates to a threshold.

19. The method according to claim 18, the method further comprising:
setting a time interval under the periodic mode;
timing when beginning to monitor communication records of the communication device;
reading the communication records generated within the time interval, and sending the read communication records to the controller.

20. The method according to claim 18, the method further comprising:
presetting the threshold under the accumulative mode;
counting the counted number of the resent communication records when beginning to monitor the communication records of the communication device; and
reading corresponding resent communication records if the counted number accumulates to the preset threshold, and sending the read unsent communication records to the controller.
